(19) United States
(12) Patent Application Publication
(10) Pub. No.: US 2025/0339321 A1
(43) Pub. Date: Nov. 6, 2025

(54) ELECTRIC VEHICLE AND VEHICLE ELECTRIC ASSIST DEVICE

(71) Applicant: JTEKT CORPORATION, Kariya-shi (JP)

(72) Inventors: Riku NAGAYAMA, Ikoma-gun (JP); Hiroshi KITAMOTO, Toyota-shi (JP); Akihiro TAKEUCHI, Takahama-shi (JP); Hiroaki KASASHIMA, Neyagawa-shi (JP); Chishin YOHENA, Nara-shi (JP); Goro TSUJI, Tondabayashi-shi (JP)

(73) Assignee: JTEKT CORPORATION, Kariya-shi (JP)

(21) Appl. No.: 18/856,190

(22) PCT Filed: Jun. 6, 2022
(86) PCT No.: PCT/JP2022/022773

§ 371 Date: Oct. 11, 2024

(51) Int. Cl. A61G 5/04

(52) U.S. Cl. CPC A61G 5/047

(57) ABSTRACT

An electric wheelchair 1 includes a vehicle body 2 including a caster 2c and a main wheel 2b, a bracket 18 fixed to the vehicle body 2, an arm 20 supported by the bracket 18 so that the arm 20 is swingable in an up-down direction, a drive wheel 14 provided at a tip 21a of the arm 20, an actuator 16 configured to drive the drive wheel 14, and an elastic member 58 that is provided between the bracket 18 and the arm 20 and biases the arm 20 downward.

### TECHNICAL FIELD

The present invention relates to an electric vehicle and a vehicle electric assist device.

### BACKGROUND ART

Patent Document 1 discloses an electric assist device for use in a wheelchair. This electric assist device includes a body including a battery, an electric motor, and a drive wheel, and an attachment bar. The electric motor drives the drive wheel. The attachment bar is a member for mounting the body on a vehicle body of the wheelchair. The position of the body to be mounted on the vehicle body via the attachment bar can be switched between a standby position and a drive position. In the standby position, the drive wheel is lifted off a road surface. In the drive position, the drive wheel is in contact with the road surface. When the drive wheel is driven in the drive position, the electric assist device assists the wheelchair in traveling.

### RELATED ART DOCUMENTS

### Patent Documents

Patent Document 1: Japanese Unexamined Patent Application Publication No. 2016-150077 (JP 2016-150077 A)

### SUMMARY OF THE INVENTION

### Problem to be Solved by the Invention

The wheelchair including the above conventional electric assist device travels with the body fixed in the drive position. Therefore, shocks and vibrations from the road surface are directly transmitted to the body via the drive wheel. Such shocks and vibrations may cause failures in the electric motor mounted on the body, peripheral devices for driving the drive wheel, etc.

Therefore, it is conceivable to mount the body so that it can move up and down to damp the vibrations from the drive wheel. In this case, however, the drive wheel is pushed against the road surface by only the weight of the body, and the contact pressure of the drive wheel cannot be secured sufficiently, which may reduce traction and hinder stable traveling.

### Means for Solving the Problem

(1) An electric vehicle according to an embodiment includes: a vehicle body including a wheel; a bracket fixed to the vehicle body; an arm supported by the bracket so that the arm is swingable in an up-down direction; a drive wheel provided at a tip of the arm; an actuator configured to drive the drive wheel; and an elastic member that is provided between the bracket and the arm and biases the arm downward.
(7) From another viewpoint, the embodiment is a vehicle electric assist device to be attached to a vehicle. The vehicle electric assist device includes: a bracket fixed to the vehicle; an arm provided on the bracket so that the arm is swingable in an up-down direction; a drive wheel provided at a tip of the arm; an actuator configured to drive the drive wheel; and an elastic member that is provided between the bracket and the arm and biases the arm downward.

### Effects of the Invention

According to the present disclosure, it is possible to increase the contact pressure of the drive wheel while damping vibrations from the drive wheel.

### BRIEF DESCRIPTION OF THE DRAWINGS

FIG. 1 is a perspective view of an electric wheelchair according to an embodiment.

FIG. 2 is a diagram showing a main part of the electric wheelchair viewed from the rear.

FIG. 3 is an enlarged view of a main part in FIG. 1.

FIG. 4 is an enlarged perspective view showing a bracket and an arm of a drive unit.

FIG. 5 is a sectional view of the bracket and the arm.

FIG. 6A is a diagram showing a relationship between a drive wheel and a main wheel when an arm body is in a lower swing position.

FIG. 6B is a diagram showing a relationship between the drive wheel and the main wheel when a vehicle body is placed on a road surface.

FIG. 7A is a diagram showing forces applied to an arm when a drive wheel is braked during traveling of an electric wheelchair in which a straight line passing through a swing center of the arm and a rotation center of the drive wheel is not parallel to the road surface.

FIG. 7B is a diagram showing a force applied to the arm when the drive wheel is braked during traveling of the electric wheelchair of the embodiment.

FIG. 8 is a diagram showing a bracket of a drive unit according to another embodiment.

### MODES FOR CARRYING OUT THE INVENTION

First, details of embodiments will be listed.

### Overview of Embodiments

(1) An electric vehicle according to an embodiment includes: a vehicle body including a wheel; a bracket fixed to the vehicle body; an arm supported by the bracket so that the arm is swingable in an up-down direction; a drive wheel provided at a tip of the arm; an actuator configured to drive the drive wheel; and an elastic member that is provided between the bracket and the arm and biases the arm downward.

The above configuration includes the elastic member that biases downward the arm that is swingable in the up-down direction. Therefore, the drive wheel can be pushed against a road surface with the wheel in contact with the road surface. As a result, it is possible to increase the contact pressure of the drive wheel while damping vibrations from the drive wheel.
(2) When the drive wheel is braked while the electric vehicle is traveling in a direction from a rotation center of the drive wheel to a swing center of the arm, a pulling force may be applied to the tip of the arm in a direction opposite to the traveling direction by the drive wheel. When such a pulling force is applied to the arm by the drive wheel, a force may be generated on the arm in a direction in which the arm rotates upward. When such a force is generated, the contact pressure of the drive wheel may decrease, and the drive wheel may vibrate in the up-down direction.

In contrast, in the present embodiment, a straight line passing through a swing center of the arm and a rotation center of the drive wheel when the wheel and the drive wheel are in contact with a road surface is parallel to the road surface.

Therefore, even though the pulling force is applied to the arm by the drive wheel, the generation of the force in the direction in which the arm rotates upward can be suppressed. As a result, the contact pressure of the drive wheel can be reduced and the vibrations of the drive wheel in the up-down direction can be reduced.
(3) The electric vehicle may further include a low friction member interposed between the bracket and the arm.
   In this case, even though a simple configuration in which the arm and the bracket are held between fastening members such as a bolt and a nut is adopted, the frictional force between the arm and the bracket can be reduced appropriately, and the arm can be provided so that it is swingable relative to the bracket.
   Further, an appropriate frictional force can be applied between the arm and the bracket by holding the arm and the bracket with the low friction member interposed therebetween. Even if a force is generated in the direction in which the arm rotates upward, the force can be reduced. Further, it is possible to reduce vibrations generated on the arm and the drive wheel by the frictional force between the arm and the bracket.
(4) In the electric vehicle, it is preferable that the bracket include a support member including a support shaft that supports the arm so that the arm is swingable, and the low friction member include a low friction washer that is provided on an outer peripheral side of the support shaft and is interposed between the arm and the support member.
(5) In the electric vehicle, the arm may include, on a base end side of the arm, a protrusion that protrudes along a longitudinal direction of the arm, and the bracket may include an upper wall portion that is provided above the protrusion and with which the protrusion comes into contact when the arm swings, and a lower wall portion that is provided below the protrusion and with which the protrusion comes into contact when the arm swings. In this case, the swing range of the protrusion can be limited by the upper wall portion and the lower wall portion. Thus, the swing range of the arm can be limited. As a result, the swinging of the arm beyond a necessary range can be suppressed.
(6) In the electric vehicle, the vehicle body may include a wheelchair.
(7) From another viewpoint, the embodiment is a vehicle electric assist device to be attached to a vehicle. The vehicle electric assist device includes: a bracket fixed to the vehicle; an arm provided on the bracket so that the arm is swingable in an up-down direction; a drive wheel provided at a tip of the arm; an actuator configured to drive the drive wheel; and an elastic member that is provided between the bracket and the arm and biases the arm downward.

The above configuration includes the elastic member that biases the arm downward. Therefore, the bracket can be fixed to the vehicle body so that the drive wheel is pushed against a road surface with the wheel of the vehicle in contact with the road surface. Therefore, the drive wheel is pushed against the road surface by the elastic member. As a result, it is possible to increase the contact pressure of the drive wheel while damping vibrations from the drive wheel.
(8) In the vehicle electric assist device, the bracket includes: a body provided with the arm; and a fixing portion that fixes the body at a predetermined height position on the vehicle. It is preferable that the predetermined height position be a position where a straight line passing through a swing center of the arm and a rotation center of the drive wheel when a wheel of the vehicle to which the vehicle electric assist device is attached and the drive wheel are in contact with a road surface is parallel to the road surface. In this case, the contact pressure of the drive wheel can be reduced and the vibrations of the drive wheel in the up-down direction can be reduced.
(9) In the vehicle electric assist device, the bracket may include: a body provided with the arm; and a fixing portion configured to adjust a height position of the body on the vehicle.
   In this case, the height position of the body can be adjusted so that the straight line passing through the swing center of the arm and the rotation center of the drive wheel when the wheel of the vehicle to which the vehicle electric assist device is attached and the drive wheel are in contact with the road surface is parallel to the road surface.
   As a result, the contact pressure of the drive wheel can be reduced and the vibrations of the drive wheel in the up-down direction can be reduced.

### Details of Embodiments

Preferred embodiments will be described below with reference to the drawings.

### Overall Configuration

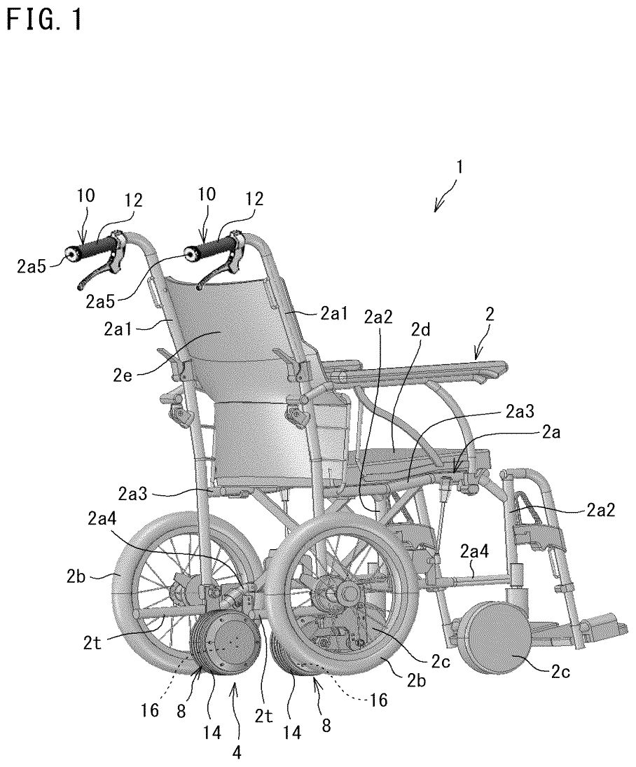

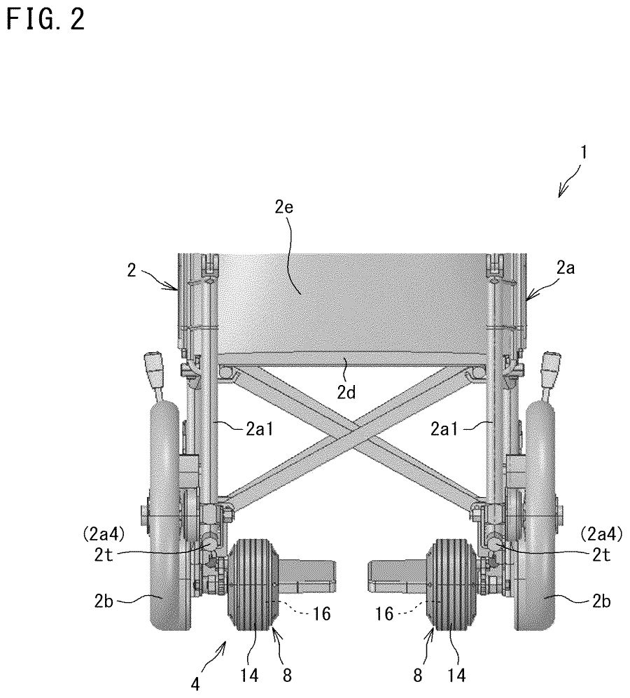

FIG. 1 is a perspective view of an electric wheelchair according to an embodiment. FIG. 2 is a diagram showing a main part of the electric wheelchair viewed from the rear.
An electric wheelchair 1 has a function of driving drive wheels of the electric wheelchair 1 when pushed from behind by an operator to assist the operator.

The electric wheelchair 1 is an electric vehicle including a vehicle body 2 and a vehicle electric assist device 4.

The vehicle body 2 is a general wheelchair, and includes a frame 2a mainly made of metal pipes, a pair of main wheels 2b, and a pair of casters 2c.
The frame 2a includes a pair of rear tubes 2a1, a pair of front tubes 2a2, a pair of upper tubes 2a3, and a pair of lower tubes 2a4.

The pair of rear tubes 2a1 extends in an up-down direction. The pair of rear tubes 2a1 is disposed parallel to each other with a predetermined distance in a right-left direction.

The pair of lower tubes 2a4 is connected to the lower ends of the pair of rear tubes 2a1.
The pair of upper tubes 2a3 is connected to the pair of rear tubes 2a1. The portions of the pair of rear tubes 2a1 where the pair of upper tubes 2a3 are connected are located above the lower ends.
The pair of upper tubes 2a3 and the pair of lower tubes 2a4 extend in a front-rear direction.
The pair of upper tubes 2a3 and the pair of lower tubes 2a4 are disposed substantially parallel to each other with predetermined distances in the right-left direction.
Portions of the pair of lower tubes 2a4 behind the rear tubes 2a1 are tipping bars 2t. The tipping bar 2t is a member that is depressed by the operator's foot. When the operator depresses the tipping bar 2t, the casters 2c are lifted upward with the main wheels 2b as pivot points.

The pair of front tubes 2a2 extends in the up-down direction. The pair of front tubes 2a2 connects the tips of the pair of upper tubes 2a3 and the tips of the pair of lower tubes 2a4. Therefore, the pair of front tubes 2a2 is shorter than the pair of rear tubes 2a1.

The pair of casters 2c is provided at the lower ends of the front tubes 2a2. The pair of main wheels 2b is provided at the lower ends of the rear tubes 2a1.

The pair of main wheels 2b is provided behind the pair of casters 2c. The pair of main wheels 2b is rear wheels. The pair of casters 2c is front wheels.
The vehicle body 2 further includes a seat portion 2d on which an occupant sits, and a backrest portion 2e. The seat portion 2d is fixed to the pair of upper tubes 2a3. The backrest portion 2e is fixed to the pair of rear tubes 2a1.
The electric wheelchair 1 is constructed by attaching the vehicle electric assist device 4 to the vehicle body 2 that can be used as the wheelchair.

In the following description, a direction in which the occupant faces the front when the occupant rides on the electric wheelchair 1 (direction in which the backrest portion 2e faces the front) is defined as a forward direction, and the opposite direction is defined as a rearward direction. Therefore, the occupant rides on the electric wheelchair 1 while facing forward. A direction in which the occupant faces the left side is defined as a leftward direction, and a direction in which the occupant faces the right side is defined as a rightward direction.

The vehicle electric assist device 4 includes a pair of drive units 8 and a pair of operation units 10.

As shown in FIG. 1, a pair of protrusions 2a5 is provided at the upper ends of the pair of rear tubes 2a1. The pair of protrusions 2a5 protrudes rearward with respect to the backrest portion 2e.
The pair of operation units 10 is provided on the pair of protrusions 2a5. Therefore, the pair of operation units 10 is disposed above the right and left sides of the backrest portion 2e.
The pair of operation units 10 includes grips 12.
The grip 12 is movable in the front-rear direction relative to the protrusion 2a5.
The operation unit 10 further includes a potentiometer (not shown). The potentiometer detects the amount of displacement of the grip 12 in the front-rear direction. The operation unit 10 provides an output indicating the amount of displacement of the grip 12 to a control device (described later).

The pair of drive units 8 is fixed to the right and left sides of the frame 2a. The pair of drive units 8 is disposed on the vehicle inner side of the pair of main wheels 2b. The pair of drive units 8 includes drive wheels 14 and actuators 16.

The actuator 16 drives the drive wheel 14. The actuator 16 is an in-wheel motor and is provided inside the drive wheel 14.
The drive unit 8 will be described in detail later.

The vehicle electric assist device 4 further includes a battery and a control box (not shown) that houses, for example, the control device that controls each part. The battery stores electric power to be supplied to the pair of drive units 8 (actuators 16) and each part.

The control device has a function of controlling the pair of actuators 16 based on outputs provided from the pair of operation units 10. As described above, the outputs of the pair of operation units 10 indicate the amounts of displacement of the pair of grips 12.
The control device controls the pair of actuators 16 based on the amounts of displacement of the pair of grips 12 to maintain the relative positions of the grips 12 and the frame 2a (vehicle body 2).
The control device can cause the actuators 16 to drive the drive wheels 14 to accelerate the vehicle body 2 or maintain the speed. The control device can brake the drive wheels 14 by causing the actuators 16 to perform regenerative braking, short circuit braking, etc., thereby decelerating the vehicle body 2.

For example, when the grips 12 are pushed forward by the operator, the grips 12 are displaced forward. The control device moves the vehicle body 2 forward based on the outputs of the pair of operation units 10 to return the grips 12 to their original positions. Conversely, when the grips 12 are pulled rearward by the operator, the grips 12 are displaced rearward. The control device moves the vehicle body 2 rearward to return the grips 12 to its original positions.

In this way, the control device adjusts the amounts of operation of the actuators 16 in response to the pushing and pulling of the grips 12 by the operator. Thus, the control device controls the pair of actuators 16 to maintain the relative positions of the grips 12 and the vehicle body 2.

### Configuration of Drive Unit

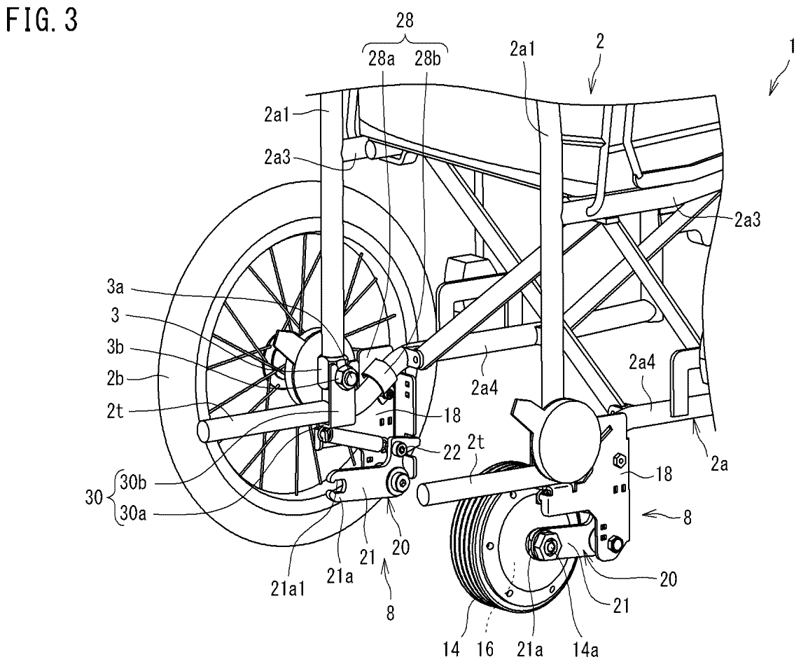

FIG. 3 is an enlarged view of a main part in FIG. 1. To facilitate understanding, the right main wheel 2b, the left drive wheel 14, and the left actuator 16 are omitted in FIG. 3.
The drive unit 8 further includes a bracket 18 and an arm 20.
The bracket 18 is a plate-shaped member. The bracket 18 is fixed to the lower tube 2a4 and the rear tube 2a1.

The arm 20 is supported by the bracket 18 so that it is swingable in the up-down direction. The arm 20 includes an arm body 21 and a protrusion 22 that is provided integrally with the arm body 21.

The tip 21a of the arm body 21 has a cutout 21a1.
An axle 14a extending from the drive wheel 14 is fixed to the cutout 21a1. Therefore, the drive wheel 14 and the actuator 16 are provided at the tip 21a of the arm body 21.
Thus, when the arm body 21 swings in the up-down direction, the drive wheel 14 and the actuator 16 move in the up-down direction.

A rotor (not shown) of the actuator 16 can rotate together with the drive wheel 14. A stator (not shown) of the actuator 16 is fixed to the arm 20 side. Thus, the actuator 16 drives the drive wheel 14 to rotate.

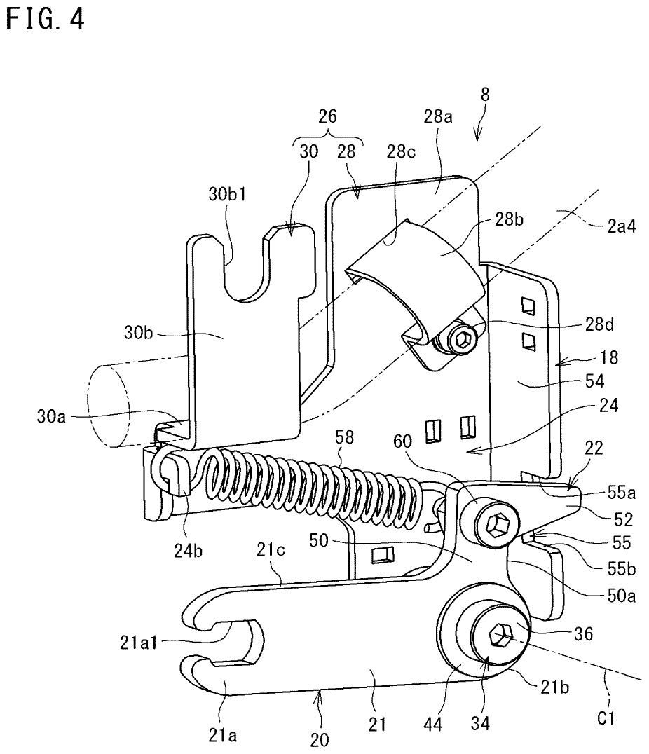

FIG. 4 is an enlarged perspective view showing the bracket 18 and the arm 20 of the drive unit 8.

FIG. 4 shows the bracket 18 and the arm 20 of the left drive unit 8. The right and left drive units 8 have the same configuration. Therefore, only the left drive unit 8 will be described.

The bracket 18 includes a body 24 and a fixing portion 26. The body 24 is provided with the arm 20.

The fixing portion 26 is provided on the upper side of the body 24. The fixing portion 26 fixes the body 24 at a predetermined height position on the vehicle body 2.
The fixing portion 26 includes a front fixing portion 28 and a rear fixing portion 30.
The front fixing portion 28 includes a rectangular plate-shaped portion 28a connected to the body 24, and a semi-cylindrical member 28b. One end of the semi-cylindrical member 28b is inserted into a slit 28c provided in the plate-shaped portion 28a and is fixed to the plate-shaped portion 28a. The other end of the semi-cylindrical member 28b is fixed to the plate-shaped portion 28a with a bolt 28d. The lower tube 2a4 passes between the plate-shaped portion 28a and the semi-cylindrical member 28b (see FIG. 3). The lower tube 2a4 is held between the plate-shaped portion 28a and the semi-cylindrical member 28b. Thus, the front fixing portion 28 is fixed to the lower tube 2a4.

The rear fixing portion 30 includes a protrusion 30a that protrudes to the vehicle inner side from an edge of the body 24, and a pillar 30b that extends upward from the tip of the protrusion 30a.

The upper surface of the protrusion 30a is in contact with the lower tube 2a4 (see FIG. 3).
A cutout 30b1 is provided at the tip of the pillar 30b. A screw 3a that protrudes from a hub 3 of the main wheel 2b fixed to the rear tube 2a1 is fixed to the cutout 30b1 (see FIG. 3). The pillar 30b is held between the hub 3 and a nut 3b that threadedly engages with the screw 3a. Thus, the rear fixing portion 30 is fixed to the rear tube 2a1.

The fixing portion 26 is fixed to the lower tube 2a4 and the rear tube 2a1. Thus, the fixing portion 26 fixes the body 24 to the frame 2a.

As shown in FIG. 4, the arm body 21 of the arm 20 provided on the body 24 swings about a central axis C1. That is, the central axis C1 is a swing center of the arm body 21.

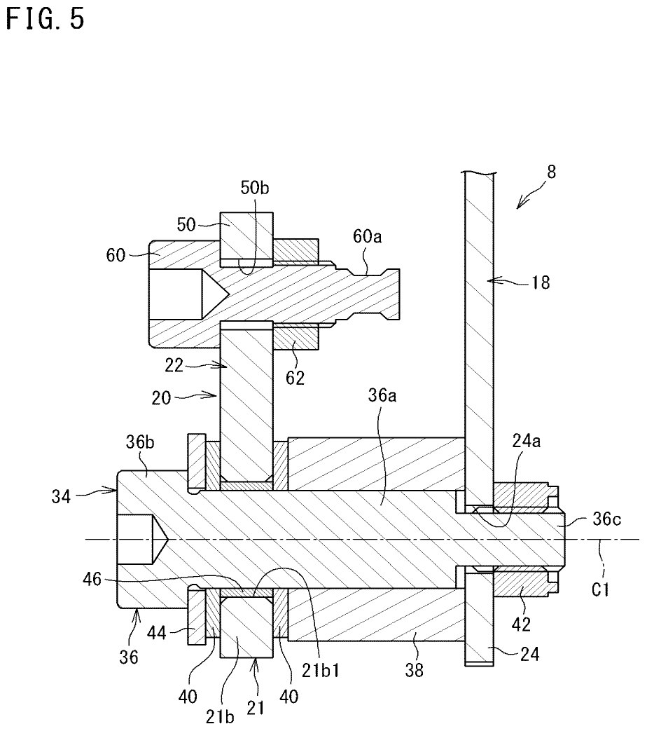

FIG. 5 is a sectional view of the bracket 18 and the arm 20. FIG. 5 shows a cross section along the up-down direction including the central axis C1.

As shown in FIG. 5, the bracket 18 further includes a support member 34. The support member 34 is a member that supports the arm 20 so that the arm 20 is swingable. The support member 34 includes a support shaft 36, a spacer 38, a washer 44, and a nut 42. The support member 34 is fixed to a support hole 24a provided in the body 24. The support hole 24a is a hole provided about the central axis C1.

The support shaft 36 includes a shaft portion 36a, a head portion 36b, and a threaded portion 36c. The head portion 36b is provided at one end of the shaft portion 36a. The threaded portion 36c is provided at the other end of the shaft portion 36a. The nut 42 threadedly engages with the threaded portion 36c.

The support member 34 is constructed by disposing the arm 20, the spacer 38, and the washer 44 on the outer peripheral side of the support shaft 36.

A pair of low friction washers 40 is attached to the support member 34. The pair of low friction washers 40 is disposed on both sides of the arm 20.
On the outer peripheral side of the support shaft 36, the washer 44, the low friction washer 40, the arm 20, the low friction washer 40, the spacer 38, and the body 24 are disposed in this order from the head portion 36b toward the threaded portion 36c.

The washer 44 is a member for preventing each member from falling off the support shaft 36.

The spacer 38 is a tubular member. The shaft portion 36a is inserted to the inner peripheral side of the spacer 38. The spacer 38 is a member for securing a distance between the body 24 and the arm 20.
A hole 21b1 is provided on a base end 21b side of the arm body 21. The shaft portion 36a is inserted into the hole 21b1. A plain bearing 46 is interposed between the hole 21b1 and the shaft portion 36a.
The pair of low friction washers 40 is washers having low friction coefficients on the front and back surfaces.
The low friction washers 40 are interposed between the arm 20 and the spacer 38 and between the arm 20 and the washer 44.
Examples of the low friction washer 40 include a normal washer having the front and back surfaces coated with a low friction material such as fluororesin that reduces the friction coefficient, and a washer made of a low friction material.
A spring washer or a wave washer may also be used as the low friction washer 40. Each of the spring washer and the wave washer can appropriately reduce the friction coefficient by reducing the contact area between the washer and the member in contact with it.

The washer 44, the low friction washer 40, the arm 20, the low friction washer 40, the spacer 38, and the body 24 are tightened between the head portion 36b and the nut 42.

That is, the arm 20, the body 24, and the other members are held between the support shaft 36 and the nut 42 that are fastening members.

Since the arm 20 is disposed between the pair of low friction washers 40, the frictional force between the arm 20 and the support member 34 can be reduced appropriately.

That is, even though the simple configuration in which the arm 20 and the body 24 are held between the fastening members is adopted as in the present embodiment, the frictional force between the arm 20 and the support member 34 can be reduced appropriately, and the arm 20 can be provided so that it is swingable relative to the support member 34 (bracket 18).

As shown in FIGS. 4 and 5, the protrusion 22 of the arm 20 is provided on the base end 21b side of the arm body 21.

The protrusion 22 includes a radial portion 50 and a longitudinal portion 52.
The radial portion 50 protrudes from a side surface 21c of the arm body 21. The radial portion 50 extends along a radial direction orthogonal to the central axis C1. Further, the radial portion 50 extends from the base end 21b in a direction intersecting the longitudinal direction of the arm body 21.
The longitudinal portion 52 extends from a side surface 50a of the radial portion 50. The longitudinal portion 52 extends in a direction opposite to the direction in which the arm body 21 extends. The longitudinal portion 52 extends substantially parallel to the longitudinal direction of the arm body 21.

As shown in FIG. 4, the bracket 18 includes a bent portion 54 that protrudes along the side edge of the body 24 to the vehicle inner side. The bent portion 54 has a recess 55. The recess 55 is provided by cutting out the edge of the bent portion 54. The recess 55 includes an upper wall portion 55a and a lower wall portion 55b. The upper wall portion 55a and the lower wall portion 55b face each other.

The longitudinal portion 52 is inserted into the recess 55. Therefore, the upper wall portion 55a is provided above the longitudinal portion 52. The lower wall portion 55b is provided below the longitudinal portion 52.

The longitudinal portion 52 (protrusion 22) is provided integrally with the arm body 21. Therefore, the longitudinal portion 52 swings along with the swinging of the arm body 21.
When the arm body 21 swings downward by a predetermined angle, the longitudinal portion 52 swings upward and comes into contact with the upper wall portion 55a. In this case, further upward swinging of the longitudinal portion 52 is restricted.
When the arm body 21 swings upward by a predetermined angle, the longitudinal portion 52 swings downward and comes into contact with the lower wall portion 55b. In this case, further downward swinging of the longitudinal portion 52 is restricted.

Therefore, the swing range of the longitudinal portion 52 (protrusion 22) is limited by the upper wall portion 55a and the lower wall portion 55b. Thus, the swing range of the arm 20 (arm body 21) can be limited. As a result, the swinging of the arm body 21 beyond a necessary range can be suppressed.

That is, the swing range of the arm body 21 is limited to the range from the position of the arm body 21 where the longitudinal portion 52 comes into contact with the upper wall portion 55a to the position of the arm body 21 where the longitudinal portion 52 comes into contact with the lower wall portion 55b.

In the following description, the position of the arm body 21 where the longitudinal portion 52 comes into contact with the upper wall portion 55a will be referred to as a lower swing position, and the position of the arm body 21 where the longitudinal portion 52 comes into contact with the lower wall portion 55b will be referred to as an upper swing position.

As shown in FIG. 4, the drive unit 8 further includes an elastic member 58. The elastic member 58 is provided between the bracket 18 and the arm 20. The elastic member 58 biases the arm 20 (arm body 21) downward.

The elastic member 58 is, for example, a helical extension spring.

An L-shaped spring hook portion 24b is provided at the rear end of the body 24.

A spring hook bolt 60 is provided on the radial portion 50 of the protrusion 22. The spring hook bolt 60 is inserted into a hole 50b of the radial portion 50 (see FIG. 5). The spring hook bolt 60 tightens the radial portion 50 by threadedly engaging with a nut 62. Thus, the spring hook bolt 60 can be fixed to the radial portion 50.

One end of the elastic member 58 is hooked onto the spring hook portion 24b. The other end of the elastic member 58 is hooked into a groove 60a at the tip of the spring hook bolt 60.

With the longitudinal portion 52 in contact with the upper wall portion 55a, the elastic member 58 applies a tensile force between the spring hook portion 24b and the spring hook bolt 60.
Therefore, when no force is applied to swing the arm body 21 upward, the arm body 21 is in the lower swing position.
When the arm body 21 is in the lower swing position, the elastic member 58 applies a tensile force between the spring hook portion 24b and the spring hook bolt 60.
Therefore, when the arm body 21 is between the lower swing position and the upper swing position, the elastic member 58 biases the arm 20 (arm body 21) downward.

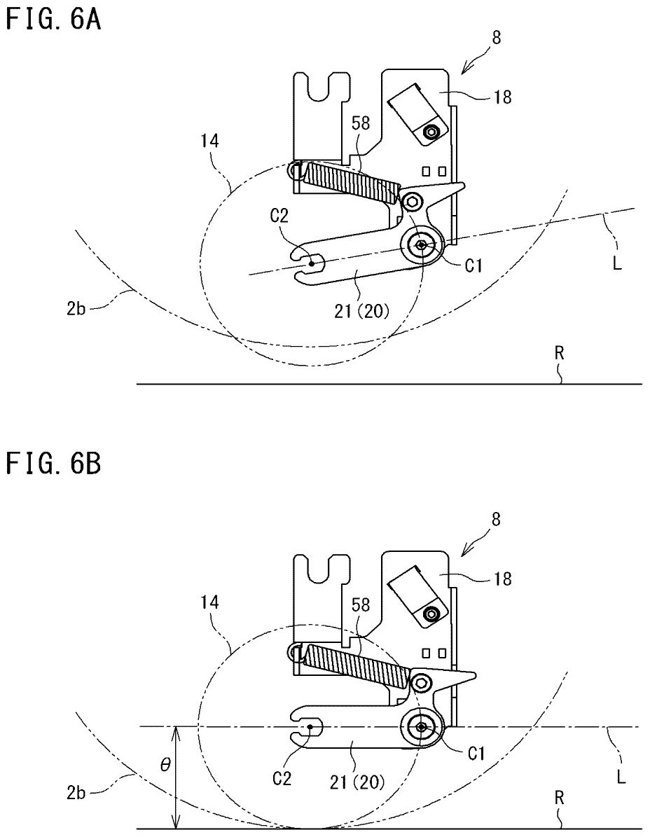

FIG. 6A is a diagram showing a relationship between the drive wheel 14 and the main wheel 2b when the arm body 21 is in the lower swing position.

As shown in FIG. 6A, when the main wheel 2b of the vehicle body 2 and the drive wheel 14 are not in contact with a road surface R, no force is applied to the arm body 21 from the road surface R. Therefore, the arm body 21 is in the lower swing position.
When the arm body 21 is in the lower swing position, the lowermost portion of the drive wheel 14 is below the lowermost portion of the main wheel 2b.

FIG. 6B is a diagram showing a relationship between the drive wheel 14 and the main wheel 2b when the vehicle body 2 is placed on the road surface R.

In this case, the caster 2c, the main wheel 2b, and the drive wheel 14 are in contact with the road surface R. Therefore, the arm body 21 is between the lower swing position and the upper swing position.
At this time, the elastic member 58 biases downward the arm body 21 that is swingable in the up-down direction. Therefore, the drive wheel 14 is pushed against the road surface R by the tensile force of the elastic member 58. As a result, the contact pressure of the drive wheel 14 can be increased while damping vibrations transmitted from the drive wheel 14 to the vehicle body 2.

In the present embodiment, a straight line L when the caster 2c, the main wheel 2b, and the drive wheel 14 are in contact with the road surface R is parallel to the road surface R. The straight line L is a straight line passing through the central axis C1 that is the swing center of the arm body 21 and a rotation center C2 of the drive wheel 14.

In the present embodiment, the description “the straight line Lis parallel to the road surface R” includes a case where the straight line Lis parallel to the road surface R, and a case where the straight line L is substantially parallel to the road surface R. The description “the straight line Lis parallel to the road surface R” means that an acute angle θ between the straight line L and a straight line along the road surface R is equal to or larger than 0 degrees and equal to or smaller than 8 degrees.

In the present embodiment, the position of the arm body 21 where the straight line L is substantially parallel to the road surface R is included between the lower swing position and the upper swing position.

Description will be given of a case where the drive wheel is braked when the electric wheelchair in which the straight line L is not parallel to the road surface R moves forward.

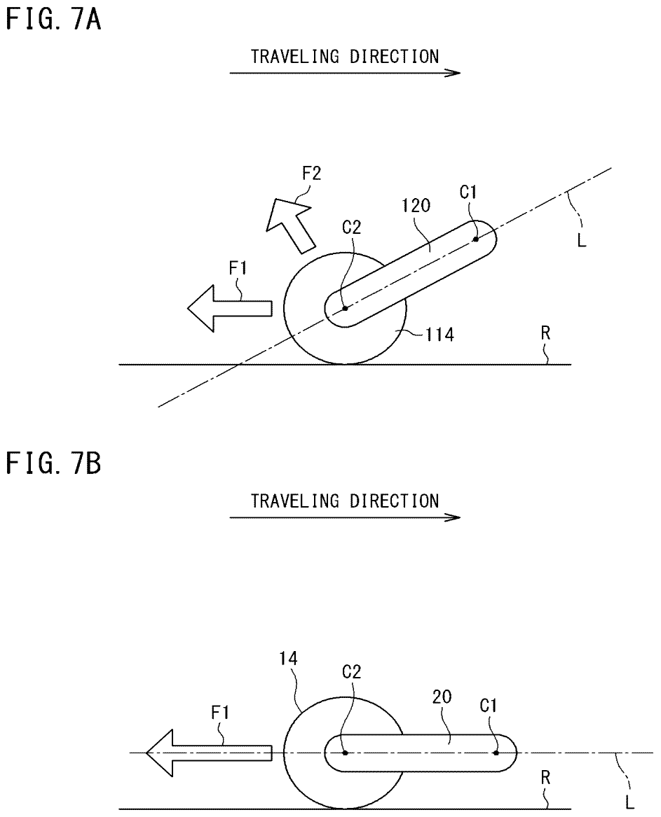

FIG. 7A is a diagram showing forces applied to an arm when a drive wheel 114 is braked during traveling of an electric wheelchair in which the straight line L is not parallel to the road surface R.
FIG. 7A shows a case where the electric wheelchair travels in a direction from the rotation center C2 of the drive wheel 114 to the central axis C1 of an arm 120 (moves forward).
In this case, the drive wheel 114 is braked (regenerative braking or short circuit braking). Therefore, a pulling force F1 is applied to a tip 120A of the arm 120 in a direction opposite to the traveling direction by the drive wheel 114. Since the straight line L is not parallel to the road surface R, a force F2 may be generated at this time on the arm 120 in a direction in which the arm 120 rotates upward.
When such a force F2 is generated on the arm 120, the contact pressure of the drive wheel 114 may decrease and the drive wheel 114 may vibrate in the up-down direction.

FIG. 7B is a diagram showing a force applied to the arm when the drive wheel is braked during traveling of the electric wheelchair of the present embodiment.

As shown in FIG. 7B, even though the pulling force is applied to the arm 20 by the drive wheel 14 when the straight line L is parallel to the road surface R, the generation of a force in a direction in which the arm 20 rotates upward can be suppressed.
As a result, the contact pressure of the drive wheel 14 can be reduced and the vibrations of the drive wheel in the up-down direction can be reduced.

In the present embodiment, an appropriate frictional force can be applied between the arm 20 and the support member 34 by holding the arm 20 and the support member 34 (bracket 18) with the low friction washers 40 interposed therebetween. Even if a force is generated in the direction in which the arm 20 rotates upward, the force can be reduced. Further, it is possible to reduce vibrations generated on the arm 20 and the drive wheel 14 by the frictional force between the arm 20 and the support member 34.

### Other Embodiments

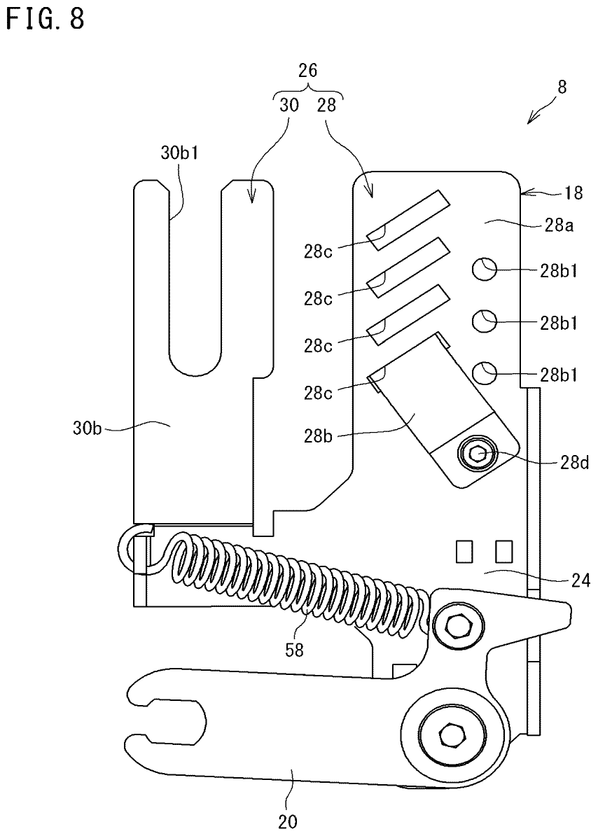

FIG. 8 is a diagram showing a bracket 18 of a drive unit 8 according to another embodiment. The present embodiment differs from the above embodiment in that the cutout 30b1 provided in the pillar 30b is longer in the height direction, and that a plurality of slits 28c and a plurality of bolt holes 28b1 are arranged along the height direction.

With the above configuration of the fixing portion 26 of the present embodiment, the height position of the body 24 on the vehicle body 2 can be adjusted.

Therefore, the height position of the body 24 can be adjusted so that the straight line L is parallel to the road surface.

As a result, the contact pressure of the drive wheel 14 can be reduced and the vibrations of the drive wheel 14 in the up-down direction can be reduced.

### Others

The embodiments disclosed herein are illustrative in all respects and not restrictive.
The above embodiments illustrate the case where the helical extension spring is used as the elastic member 58, but an annular rubber etc. may be used instead of the helical extension spring.

The above embodiments illustrate the case where the position of the arm body 21 where the straight line L is substantially parallel to the road surface R is included between the lower swing position and the upper swing position, but the lower swing position and the upper swing position may be included in the range of the position of the arm body 21 where the straight line L is substantially parallel to the road surface R.

In this case, the swing range of the arm body 21 can be limited to the range in which the straight line Lis substantially parallel to the road surface R.

The above embodiments illustrate the vehicle body 2 including the front and rear wheels (casters 2c and main wheels 2b), but the vehicle body 2 may include at least either of the front and rear wheels.

The above embodiments illustrate the case where the vehicle electric assist device 4 is attached to the vehicle body 2 that is a general wheelchair, but the vehicle body 2 may be a dolly, a wagon, etc. other than the wheelchair.

The scope of the present invention is not limited to the above embodiments, and includes all changes made within the scope of equivalents to the configurations set forth in the claims.

### DESCRIPTION OF THE REFERENCE NUMERALS

2 . . . vehicle body, 4 . . . vehicle electric assist device, 14 . . . drive wheel, 16 . . . actuator, 18 . . . bracket, 20 . . . arm, 21a . . . tip, 21b . . . base end, 22 . . . protrusion, 24 . . . body, 26 . . . fixing portion, 34 . . . support member, 36 . . . support shaft, 40 . . . low friction washer (low friction member), 55a . . . upper wall portion, 55b . . . lower wall portion, 58 . . . elastic member

1. An electric vehicle comprising:
a vehicle body including a wheel;
a bracket fixed to the vehicle body;
an arm supported by the bracket so that the arm is swingable in an up-down direction;
a drive wheel provided at a tip of the arm;
an actuator configured to drive the drive wheel; and
an elastic member that is provided between the bracket and the arm and biases the arm downward, wherein
the arm includes, on a base end side of the arm, a protrusion that protrudes along a longitudinal direction of the arm, and
the bracket includes an upper wall portion that is provided above the protrusion and with which the protrusion comes into contact when the arm swings, and a lower wall portion that is provided below the protrusion and with which the protrusion comes into contact when the arm swings.

2. The electric vehicle according to claim 1, wherein a straight line passing through a swing center of the arm and a rotation center of the drive wheel when the wheel and the drive wheel are in contact with a road surface is parallel to the road surface.

3. The electric vehicle according to claim 2, further comprising a low friction member interposed between the bracket and the arm.

4. The electric vehicle according to claim 3, wherein
the bracket includes a support member including a support shaft that supports the arm so that the arm is swingable, and
the low friction member includes a low friction washer that is provided on an outer peripheral side of the support shaft and is interposed between the arm and the support member.

5. (canceled)

6. The electric vehicle according to claim 1, wherein the vehicle body includes a wheelchair.

7. A vehicle electric assist device to be attached to a vehicle,
the vehicle electric assist device comprising:
a bracket fixed to the vehicle;
an arm provided on the bracket so that the arm is swingable in an up-down direction;
a drive wheel provided at a tip of the arm;
an actuator configured to drive the drive wheel; and
an elastic member that is provided between the bracket and the arm and biases the arm downward, wherein
the arm includes, on a base end side of the arm, a protrusion that protrudes along a longitudinal direction of the arm, and
the bracket includes an upper wall portion that is provided above the protrusion and with which the protrusion comes into contact when the arm swings, and a lower wall portion that is provided below the protrusion and with which the protrusion comes into contact when the arm swings.

8. The vehicle electric assist device according to claim 7, wherein
the bracket includes:
a body provided with the arm; and
a fixing portion that fixes the body at a predetermined height position on the vehicle, and
the predetermined height position is a position where a straight line passing through a swing center of the arm and a rotation center of the drive wheel when a wheel of the vehicle to which the vehicle electric assist device is attached and the drive wheel are in contact with a road surface is parallel to the road surface.

9. The vehicle electric assist device according to claim 7, wherein the bracket includes:
a body provided with the arm; and
a fixing portion configured to be able to adjust a height position of the body on the vehicle.
